(19) United States
(12) Patent Application Publication
(10) Pub. No.: US 2008/0118228 A1
(43) Pub. Date: May 22, 2008

(54) Information Recording Device and Method, Information Reproducing Device and Method, Information Recording/Reproducing Device and Method, and Computer Program

(75) Inventors: Tomohiro Miura, Saitama (JP); Kenji Yamagata, Saitama (JP); Hiroshi Nakamura, Saitama (JP); Ken Miyagawa, Saitama (JP); Yukio Numakami, Saitama (JP); Kenichiro Tada, Saitama (JP); Shinya Hashimoto, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 11/661,675

(22) PCT Filed: Aug. 30, 2005
(86) PCT No.: PCT/JP05/15758

§ 371 Date: May 31, 2007

(30) Foreign Application Priority Data
Sep. 3, 2004 (JP) 2004-256737

(51) Int. Cl. H04N 5/91

(52) U.S. Cl. 386/123

(57) ABSTRACT

An information device (300) includes: first judgment elements (304) for judging whether an information recording device specified by circumstances information (400a) recorded on a second recording medium (100) coincides with the information recording device which has performed MOVE process; and control elements (307) for controlling display elements (305, etc.) so as to display that the first content information (HD content) can be reproduced if the coincidence is confirmed by the first judgment elements, controlling the content information generation elements (308, etc.) so as to generate first content information according to the circumstances information, and controlling the reproducing elements (310, etc.) so as to reproduce the generated first content information.

### TECHNICAL FIELD

The present invention relates to an information recording apparatus and an information recording method, an information reproducing apparatus and an information reproducing method, such as a DVD recorder and a DVD player, and a computer program product which makes a computer function as the information recording apparatus and the like.

### BACKGROUND ART

Nowadays, terrestrial digital broadcasting and BS digital broadcasting or the like are started, and even at home, an environment for watching high definition digital broadcasting is being improved. In such digital broadcasting, it is possible for users to watch Hi-vision broadcasting or content information having the quality of HDTV (hereinafter referred to HD (High Definition)), which advances from so-called standard broadcasting or content information having the quality of SDTV (hereinafter referred to as SD (Standard Definition)).

On the other hand, the content information broadcasted by such digital broadcasting is digital data, so that duplicating or copying does not deteriorate image quality, and it is possible to make a copy, easily. Thus, the copying of the digital data (or the content information related to the digital broadcasting) is an issue in regard to copyright protection. In order to realize such copyright protection, various technologies for copyright protection have been developed (refer to patent documents 1 to 3). In particular, CPPM (Content Protection for Prerecorded Media) and CPRM (Content Protection for Recording Media) in the technologies for copyright protection, which are adopted on recording media, such as a DVD, are intended to prevent illegal copying, in which the copyright of the content information is properly protected by imposing a copy-once limitation on the content information.

### Patent document 1: Japanese Patent Application Laid Open NO. 2000-324443

### Patent document 2: Japanese Patent Application Laid Open NO. 2000-298926

### Patent document 3: Japanese Patent Application Laid Open NO. H09-171658

### DISCLOSURE OF INVENTION

### Subject to be Solved by the Invention

The “copy-once limitation” has been put on all programs (or content information) broadcasted in Japan since April, 2004, in the terrestrial digital broadcasting and the BS digital broadcasting, in order to protect the copyrights.

This “copy-once limitation” allows a so-called “MOVE operation (i.e. MOVE process)” only in which the original content information recorded in a hard disk or the like is deleted, if the content information recorded in the hard disk is moved into/onto another record medium such as the DVD. For example, some users tend to record HD content information into a hard disk at home and then record this HD content information into a DVD or the like in order to enjoy this content anywhere out of home. In this case, the HD content information recorded in the hard disk is recorded as another SD content information into the DVD or the like and this original HD content information is deleted from the hard disk, in conformity with the MOVE operation. This MOVE operation allows transferring the content information with the “copy-once limitation” into/onto another record medium, while suitably protecting the copyright of the content information.

Moreover, there has been also invented such a technology that the SD content information, which is moved to another recording medium by one information recording/reproducing apparatus in conformity with the MOVE-operation, can be restored to the HD content information again (hereinafter referred to as “HD restoration/reproduction”, as occasion demands). Therefore, users can watch the restored HD content information only on the information recording/reproducing apparatus which performed the MOVE operation.

However, for example, if a user has a plurality of information recording/reproducing apparatuses at home, the user cannot know which apparatus is operable to perform the HD restoration/reproduction. Thus, there is such a problem that the user needs to start all the apparatuses to check whether or not the HD restoration/reproduction can be performed. Such a problem may halve the convenience and attractiveness of information equipment, such as a DVD recorder, equipped with a hard disk, and it is not preferable.

It is therefore an object of the present invention to provide: an information recording apparatus and method, an information reproducing apparatus and method, and an information recording/reproducing apparatus and method, which enable a user to watch the content information, highly conveniently, while preferably protecting the copyright, and a computer program product which makes a computer function as the information recording apparatus and the like.

### Means for Solving the Subject

### (Information Recording Apparatus)

The above object of the present invention can be achieved by an information recording apparatus for performing a MOVE process of moving first content information in first reproduction quality, which is recorded on a first recording medium (HD), to a second recording medium (DVD), the information recording apparatus provided with: a MOVE processing device for performing the MOVE process; and a history information generating device for generating history information, which at least includes information about a history of the MOVE process and information capable of specifying the information recording apparatus.

According to the information recording apparatus of the present invention, by the operation of the history information generating device, the history information is generated including the information capable of specifying the information recording apparatus which will perform or performed the MOVE process and the information about the history of the MOVE process performed by the MOVE processing device (e.g. about which first content information is moved from which recording medium or apparatus to which recording medium or the like, as described later).

Therefore, as described later, for example, when the first content information is generated from difference information and scramble information, the legally moved first content information can be preferably reproduced by one of plural of information recording apparatus by referring to the history information.

On the other hand, the illegal reproduction of the first content information or the like from the illegally duplicated difference information or the like can be preferably prevented by referring to the history information. For example, even if a reproduction instruction is given using the difference information recorded on the first recording medium provided for another information recording apparatus which originally does not perform the MOVE process on the first content information, the illegal reproduction can be prevented.

Therefore, while the copyright of contents is preferably protected, a user can watch the first content information again in the first reproduction quality on the basis of the history information, even after the content information down-converted from, for example, the first reproduction quality to the second reproduction quality which is lower definition (e.g. second content information) is recorded onto another recording medium. Namely, for example, even if a relatively high definition digital broadcast program is recorded onto the first recording medium, and then down-converted to a relatively low definition program and recorded onto the second recording medium, the user can watch it as the relatively high definition program again. Of course, the user also can watch it as the low definition program.

In particular, on the basis of the history information, the information indicating the one of plural of information recording apparatus which properly performed the MOVE process on the first content information can be displayed to the user. By this, it is possible to provide the user with high convenience.

Consequently, according to the information recording apparatus of the present invention, while the copyright of contents is preferably protected, the user can watch the content information, highly conveniently.

In one aspect of the information recording apparatus of the present invention, the MOVE processing device is provided with: a down-convert device for down-converting the first content information to second content information in second reproduction quality, which is lower definition than the first reproduction quality; a first recording device for recording at least the second content information out of the generated history information and the second content information onto the second recording medium (DVD); and a deleting device for deleting the first content information recorded on the first recording medium (HD), if the second content information is recorded onto the second recording medium (DVD).

According to this aspect, by the operation of the down-convert device provided for the MOVE processing device, the first content information in the first reproduction quality (HD) recorded on the first recording medium is down-converted to generate the second content information in the second reproduction quality (SD). At this time, since the second reproduction quality is lower definition than the first reproduction quality, the data size of the second content information is smaller than that of the first content information. Then, the generated second content information is recorded onto the second recording medium by the operation of the first recording device.

On the other hand, after the second content information is recorded onto the second recording medium, by the operation of the deleting device, the first content information recorded on the first recording medium is deleted. By this, the copyright of contents can be properly protected.

In addition, the history information is recorded onto the second recording medium to which the first content information is properly moved. Therefore, even if only the history information is illegally recorded, the reproduction of the first content information or the like, described later, cannot be performed by using the history information without the second recording medium to which the first content information is moved. Therefore, the copyright of contents can be protected, more preferably.

Consequently, according to the information recording apparatus of the present invention, while the copyright of contents is preferably protected, the user can preferably watch the content information in the desired reproduction quality (e.g. the first reproduction quality corresponding to HD image quality described later, or the second reproduction quality corresponding to SD image quality described later.

In an aspect associated with the first recording device, the first recording device may further perform a predetermined encryption process on at least one of the second content information and the history information.

By virtue of such construction, by performing the predetermined encryption process on at least one of the second content information and the history information, it is possible to more effectively prevent the disadvantage that the restoration/reproduction is performed from the illegally copied second content information (SD) to the first content information (HD). Namely, not only the legality of the second recording medium (e.g. the legality that the MOVE process is legally performed) is confirmed by using the history information which is not encrypted, but also the legality of the second content information to be recorded onto the second recording medium (DVD), the history information, and an information reproducing apparatus or the like is confirmed by using the predetermined encrypted process. Therefore, while the copyright of contents is protected, more preferably, the first and second content information or the like can be also reproduced preferably.

In an aspect associated with the down-convert device, the down-convert device may separate the first content information into the second content information and difference information which can be restored and reproduced by adding it to the second content information but which cannot be reproduced solo, to thereby perform the down-converting.

By virtue of such construction, it is possible to perform the process when the restoration/reproduction is performed from the second content information (SD) to the first content information (HD), quickly and accurately, as compared to a predetermined decoding process, such as, for example, a descramble process.

In another aspect of the information recording apparatus of the present invention, the MOVE processing device is provided with: a scrambling device for generating scramble information instead of deleting the first content information by performing a scramble process on the first content information on the basis of a predetermined scramble key, and the history information generating device generates history information further indicating a history of the scramble process.

According to this aspect, by the operation of the scrambling device, the scramble process is performed on the first content information on the basis of the predetermined scramble key. As a result, the scramble information is generated from the first content information. Here, the “scramble process” in the present invention indicates, in effect, a process of converting the content information that represents predetermined video images or the like to information that itself cannot represent the predetermined video images or the like (i.e. the scramble information). Therefore, as long as the scramble information is generated, the copyright of contents can be properly protected.

In another aspect of the information recording apparatus of the present invention, it is further provided with a second recording device for recording at least one of the difference information and the history information onto the first recording medium.

According to this aspect, using at least one of the history information and the difference information recorded on the first recording medium, various operations described later (particularly, an operation of generating the first content information) can be properly performed.

In another aspect of the information recording apparatus of the present invention, the history information generating device generates, as at least one portion of the history information, information capable of specifying at least one of the first content information on which the MOVE process is performed, the second recording medium, a recording position on the second recording medium of the second content information on which the MOVE process is performed, and the difference information separated by the MOVE process.

According to this aspect, by referring to the history information, as occasion demands, the illegal reproduction of the first content information or the like can be prevented, more effectively. Therefore, the copyright of contents can be protected, more properly. Incidentally, in addition to this, for example, information about the second recording medium (an optical disc, such as a DVD) which is the destination of the MOVE process, the scramble key in the scramble process, or the like may be included in the history information.

### (Information Recording Method)

The above object of the present invention can be also achieved by an information recording method on an information recording apparatus for performing a MOVE process of moving first content information in first reproduction quality, which is recorded on a first recording medium (HD), to a second recording medium (DVD), the information recording method provided with: a MOVE processing process of performing the MOVE process; and a history information generating process of generating history information, which at least includes information about a history of the MOVE process and information capable of specifying the information recording apparatus.

According to the information recording method of the present invention, it is possible to receive the same various benefits as those of the above-mentioned information recording apparatus of the present invention.

Incidentally, in response to the various aspects of the above-mentioned information recording apparatus of the present invention, the information recording method of the present invention can also adopt various aspects.

### (Information Reproducing Apparatus)

The above object of the present invention can be also achieved by an information reproducing apparatus for reproducing the first content information moved from the first recording medium (HD) to the second recording medium (DVD) by the above-mentioned information recording apparatus of the present invention (including its various aspects), the information reproducing apparatus provided with: an obtaining device for obtaining history information recorded on the second recording medium (DVD); a first judging device for judging whether or not an information recording apparatus specified by the obtained history information targeted for reproduction by the information reproducing apparatus matches the information recording apparatus which performed the MOVE process; a displaying device for displaying whether or not the first content information can be reproduced on the information reproducing apparatus; a content information generating device for generating the first content information on the basis of the history information; a reproducing device for reproducing the generated first content information or the second content information recorded on the second recording medium (DVD); and a controlling device for controlling the displaying device to display an indication that the first content information can be reproduced, controlling the content information generating device to generate the first content information, and controlling the reproducing device to reproduce the generated first content information, if it is judged by the first judging device that the both apparatuses match.

According to the information reproducing apparatus of the present invention, firstly, by the obtaining device, the history information is obtained which indicates the history of one MOVE process and which is recorded on the second recording medium, such as, for example, a DVD. Then, under the control of the first judging device, it is judged whether or not the information recording apparatus specified by the obtained history information targeted for the reproduction by the information reproducing apparatus matches the information recording apparatus which performed the one MOVE process. Then, under the control of the controlling device, the displaying device is controlled to display the indication that the first content information can be reproduced, if it is judged by the first judging device that the both apparatuses match. At the same time, the content information generating device is controlled to generate the first content information. Also, the reproducing device is controlled to reproduce the generated first content information.

Therefore, the copyright of contents in the MOVE process can be properly protected by recognizing the combination of the second recording medium and the information recording apparatus including the first recording medium on which the one MOVE process is performed, on the basis of the history information indicating the history of the one MOVE process,

In addition, since the history information includes the information capable of uniquely specifying the information recording apparatus which performed the one MOVE process, even if the second recording medium is inserted on another information recording apparatus which does not perform the one MOVE process, the information indicating the one information recording medium can be displayed to the user. Moreover, on the basis of the history information recorded on the first recording medium in the one of plural of information recording apparatus, first content information can be restored and reproduced.

Consequently, according to the information reproducing apparatus of the present invention, while the copyright of contents is properly protected, the user can watch the first content information in the desired reproduction quality (particularly, the first reproduction quality), highly conveniently.

Incidentally, in response to the various aspects of the above-mentioned information recording apparatus of the present invention, the information reproducing apparatus of the present invention can also adopt various aspects.

In one aspect of the information reproducing apparatus of the present invention, it is further provided with: a second judging device for judging whether or not the difference information or the scramble information is recorded on the first recording medium (HD) on which the MOVE process is performed by the matching information recording apparatus, the controlling device controlling the displaying device to display an indication that the first content information (HD) can be reproduced, controlling the content information generating device to generate the first content information, and controlling the reproducing device to reproduce the generated first content information, if it is judged by the second judging device that the information is recorded.

According to this aspect, under the control of the second judging device, it is judged whether or not the difference information or the scramble information is recorded on the first recording medium (JD) on which the MOVE process is performed on the information recording apparatus specified by the history information, which is recorded on the second recording medium targeted for the reproduction by the information reproducing apparatus, i.e. which is recorded on the matching information recording apparatus.

Under the control of the controlling device, the displaying device is controlled to display the indication that the first content information (HD) can be reproduced, if it is judged by the second judging device that it is recorded. At the same time, the content information generating device is controlled to generate the first content information. Also, the reproducing device is controlled to reproduce the generated first content information.

Therefore, by judging whether or not the difference information or the scramble information is recorded on the first recording medium in the information recording apparatus which performed the one MOVE process, it is possible to let the user know about the actual possibility of the reproduction of the first content information (HD).

As a result, according to this aspect, the user can watch the first content information in the desired reproduction quality (particularly, the first reproduction quality), highly conveniently.

In an aspect associated with the controlling device, the controlling device may control the displaying device to display an indication that the first content information cannot be reproduced and controls the reproducing device to reproduce the second content information (SD), if it is judged by the second judging device that the information is not recorded.

By virtue of such construction, in case that the difference information or the scramble information is not recorded on the first recording medium in the information recording apparatus which performed the one MOVE process, it is possible to let the user know that only the second content information (SD) can be reproduced.

As a result, according to this aspect, the user can watch the second content information in the desired reproduction quality (particularly, the second reproduction quality), highly conveniently.

In another aspect of the information reproducing apparatus of the present invention, the displaying device is further capable to display information indicating the information recording apparatus specified by the history information recorded on the second recording medium (DVD), and the controlling device controls the displaying device to display an indication that the first content information cannot be reproduced and information indicating the specified information recording apparatus, and controls the reproducing device to reproduce the second content information (SD), if it is judged by the first judging device that the both apparatuses do not match.

According to this aspect, under the control of the controlling device, the displaying device is controlled to display the indication that the first content information cannot be reproduced and the information indicating the specified information recording apparatus, if it is judged by the first judging device that the both apparatuses do not match. At the same time, the reproducing device is controlled to reproduce the second content information (SD).

Therefore, since the history information includes the information capable of uniquely specifying the information recording apparatus which performed the one MOVE process, as described above, even if the second recording medium is inserted on another information recording apparatus which does not perform the one MOVE process, the information indicating the one of plural of information recording apparatus can be displayed to the user.

As a result, according to this aspect, the user can watch the first content information in the desired reproduction quality (particularly, the first reproduction quality), highly conveniently.

In another aspect of the information reproducing apparatus of the present invention, the second content information is recorded on the second recording medium through a predetermined encryption process, and the reproducing device further decodes and reproduces the second content information.

According to this aspect, by performing the predetermined encryption process, it is possible to more effectively prevent the disadvantage that the restoration/reproduction is performed from the illegally copied second content information (SD) to the first content information (HD). Namely, not only the legality of the second recording medium (e.g. the legality that the MOVE process is legally performed) is confirmed using the history information, but also the legality of the second recording medium (DVD), and the information reproducing apparatus or the like is confirmed by using the predetermined encrypted process. Therefore, while the copyright of contents is protected more preferably, the first and second content information or the like can be also reproduced preferably.

In another aspect of the information reproducing apparatus of the present invention, the content information generating device adds the difference information to the second content information, to thereby generate the first content information.

According to this aspect, it is possible to perform the process when the restoration/reproduction is performed from the second content information (SD) to the first content information (HD), quickly and accurately, as compared to a predetermined decoding process, such as, for example, a descramble process.

In an aspect associated with the controlling device, it may be constructed such that recording area management information can be recorded on the first recording medium, the recording area management information being intended to manage whether a recording area is recorded condition or unrecorded condition can be recorded, that the information reproducing apparatus is connected to an external network through which information can be shared with another information reproducing apparatus, and that the controlling device controls the displaying device to share, via the external network, the history information and the recording area management information, and to display information indicating whether or not there is the difference information, in the another information reproducing apparatus.

By virtue of such construction, since it can be judged whether or not there is the difference information on the information recording apparatus which performed another MOVE process on the basis of the recording area management information and the history information shared via the external network, it is possible to let the user about the actual possibility of the reproduction of the first content information (HD) on another information recording apparatus in addition to the information reproducing apparatus.

As a result, according to this aspect, the user can watch the first content information in the desired reproduction quality (particularly, the first reproduction quality), highly conveniently.

Moreover, in an aspect associated with the controlling device, it may be further provided with a copyright protecting device for allowing or prohibiting the sharing of information between the information reproducing apparatus and another information reproducing apparatus, the controlling device controlling the content information generating device to share the difference information via the external network and to generate the first content information on the basis of the shared difference information, and controls the reproducing device to reproduce the generated first content information, if the sharing of the difference information is allowed by the copyright protecting device.

By virtue of such construction, since the first content information (HD) can be generated on the basis of the difference information shared via the external network, the first content information (HD) can be reproduced on the information reproducing apparatus via another information recording apparatus.

As a result, according to this aspect, the user can watch the first content information in the desired reproduction quality (particularly, the first reproduction quality), highly conveniently.

### (Information Reproducing Method)

The above object of the present invention can be also achieved by an information reproducing method on an information reproducing apparatus provided with a reproducing device for reproducing the first content information moved from the first recording medium (HD) to the second recording medium (DVD) by the above-mentioned information recording apparatus of the present invention (including its various aspects) or reproducing the second content information recorded on the second recording medium (DVD), the information reproducing method provided with: an obtaining process of obtaining history information recorded on the second recording medium (DVD); a first judging process of judging whether or not an information recording apparatus specified by the obtained history information targeted for reproduction by the information reproducing apparatus matches the information recording apparatus which performed the MOVE process; a displaying process of displaying whether or not the first content information can be reproduced on the information reproducing apparatus; a content information generating process of generating the first content information on the basis of the history information; and a controlling process of controlling the displaying process to display an indication that the first content information can be reproduced, controlling the content information generating process to generate the first content information, and controlling the reproducing device to reproduce the generated first content information, if it is judged by the first judging device that the both apparatuses match.

According to the information reproducing method of the present invention, it is possible to receive the same various benefits as those of the above-mentioned information reproducing apparatus of the present invention.

Incidentally, in response to the various aspects of the above-mentioned information reproducing apparatus of the present invention, the information reproducing method of the present invention can also adopt various aspects.

### (Information Recording/Reproducing Apparatus)

The above object of the present invention can be also achieved by an information recording/reproducing apparatus for performing a MOVE process of moving first content information in first reproduction quality, which is recorded on a first recording medium (HD), to a second recording medium (DVD), the information recording/reproducing apparatus provided with: a MOVE processing device for performing the MOVE process; a history information generating device for generating history information, which at least includes information about a history of the MOVE process and information capable of specifying the information recording apparatus; an obtaining device for obtaining history information recorded on the second recording medium (DVD); a first judging device for judging whether or not an information recording apparatus specified by the obtained history information targeted for reproduction by the information reproducing apparatus matches the information recording apparatus which performed the MOVE process; a displaying device for displaying whether or not the first content information can be reproduced on the information reproducing apparatus; a content information generating device for generating the first content information on the basis of the history information; a reproducing device for reproducing the generated first content information or the second content information recorded on the second recording medium (DVD); and a controlling device for controlling the displaying device to display an indication that the first content information can be reproduced, controlling the content information generating device to generate the first content information, and controlling the reproducing device to reproduce the generated first content information, if it is judged by the first judging device that the both apparatuses match.

According to the information recording/reproducing apparatus of the present invention, it is possible to receive the same various benefits as those of each of the above-mentioned information recording apparatus and information reproducing apparatus of the present invention.

Incidentally, in response to the various aspects of the above-mentioned information recording apparatus or information reproducing apparatus of the present invention, the information recording/reproducing apparatus of the present invention can also adopt various aspects.

### (Information Recording/Reproducing Apparatus)

The above object of the present invention can be also achieved by an information recording/reproducing method on an information recording/reproducing apparatus for performing a MOVE process of moving first content information in first reproduction quality, which is recorded on a first recording medium (HD), to a second recording medium (DVD), the information recording/reproducing apparatus provided with a reproducing device for reproducing various information, the information recording/reproducing method provided with: a MOVE processing process of performing the MOVE process; a history information generating process of generating history information, which at least includes information about a history of the MOVE process and information capable of specifying the information recording apparatus; an obtaining process of obtaining history information recorded on the second recording medium (DVD); a first judging process of judging whether or not an information recording apparatus specified by the obtained history information targeted for reproduction by the information reproducing apparatus matches the information recording apparatus which performed the MOVE process; a displaying process of displaying whether or not the first content information can be reproduced on the information reproducing apparatus; a content information generating process of generating the first content information on the basis of the history information; and a controlling device for controlling the displaying process to display an indication that the first content information can be reproduced, controlling the content information generating process to generate the first content information, and controlling the reproducing device to reproduce the generated first content information, if it is judged by the first judging device that the both apparatuses match.

According to the information recording/reproducing method of the present invention, it is possible to receive the same various benefits as those of each of the above-mentioned information recording method and information reproducing method of the present invention.

Incidentally, in response to the various aspects of the above-mentioned information recording method or information reproducing method of the present invention, the information recording/reproducing method of the present invention can also adopt various aspects.

### (Computer Program)

The above object of the present invention can be also achieved by a first computer program of instructions for tangibly embodying a program of instructions executable by a computer, to make the computer function as at least one portion of the above-mentioned information recording apparatus (including its various aspects). The above object of the present invention can be also achieved by a second computer program of instructions for tangibly embodying a program of instructions executable by a computer, to make the computer function as at least one portion of the above-mentioned information reproducing apparatus (including its various aspects). The above object of the present invention can be also achieved by a third computer program of instructions for tangibly embodying a program of instructions executable by a computer, to make the computer function as at least one portion of the above-mentioned information recording/reproducing apparatus (including its various aspects).

According to each of the computer programs of the present invention, the above-mentioned information recording apparatus, information reproducing apparatus, or information recording/reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

The above object of the present invention can be also achieved by a first computer program product in a computer-readable medium for tangibly embodying a program of instructions executable by a computer, to make the computer function as at least one portion of the above-mentioned information recording apparatus (including its various aspects).

The above object of the present invention can be also achieved by a second computer program product in a computer-readable medium for tangibly embodying a program of instructions executable by a computer, to make the computer function as at least one portion of the above-mentioned information reproducing apparatus (including its various aspects).

The above object of the present invention can be also achieved by a third computer program product in a computer-readable medium for tangibly embodying a program of instructions executable by a computer, to make the computer function as at least one portion of the above-mentioned information recording/reproducing apparatus (including its various aspects).

According to each of the computer program products of the present invention, the above-mentioned information recording apparatus, information reproducing apparatus, or information recording/reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned information recording apparatus, information reproducing apparatus, or information recording/reproducing apparatus of the present invention.

Incidentally, in response to the various aspects of the above-mentioned information recording apparatus, information reproducing apparatus, or information recording/reproducing apparatus of the present invention, each of the computer programs of the present invention can also adopt various aspects.

These effects and other advantages of the present invention will become more apparent from the following embodiments.

As explained above, according to the information recording apparatus of the present invention, it is provided with the MOVE processing device, and the history information generating device, and according to the information recording method of the present invention, it is provided with the MOVE processing process, and the history information generating process. Moreover, according to the information reproducing apparatus of the present invention, it is provided with the obtaining device, the first judging device, the displaying device, the content information generating device, the reproducing device, and the controlling device, and according to the information recording method of the present invention, it is provided with the obtaining process, the first judging process, the displaying process, the content information generating process, and the controlling process. Therefore, while the copyright of contents is preferably protected, the user can watch the content information, highly conveniently.

### BRIEF DESCRIPTION OF DRAWINGS

FIG. 1 is a block diagram conceptually showing the basic configuration upon recording of an information recording/reproducing apparatus in a first embodiment.

FIG. 2 is a flowchart conceptually showing a flow of a MOVE process of the information recording/reproducing apparatus in the first embodiment.

FIG. 3 is a data structure view conceptually showing “history information” of the present invention.

FIG. 4 is a block diagram conceptually showing the basic configuration upon reproduction of the information recording/reproducing apparatus in the first embodiment.

FIG. 5 is a flowchart conceptually showing a flow of a reproduction operation and display operation of the information recording/reproducing apparatus in the first embodiment.

FIG. 6 is a diagram showing one specific example of a menu displayed by a GUI display apparatus, which is one example of the displaying device in the first embodiment.

FIG. 7 is a diagram showing another specific example of the menu displayed by the GUI display apparatus, which is one example of the displaying device in the first embodiment.

FIG. 8 is a diagram showing another specific example of the menu displayed by the GUI display apparatus, which is one example of the displaying device in the first embodiment.

FIG. 9 is a block diagram conceptually showing the basic configuration upon reproduction of an information recording/reproducing apparatus in a second embodiment.

FIG. 10 is a flowchart conceptually showing a flow of a reproduction operation and display operation of the information recording/reproducing apparatus in the second embodiment.

FIG. 11 is a diagram showing one specific example of a menu displayed by a GUI display apparatus, which is one example of the displaying device in the second embodiment.

FIG. 12 is a diagram showing another specific example of the menu displayed by the GUI display apparatus, which is one example of the displaying device in the second embodiment.

FIG. 13 is a block diagram conceptually showing the basic configuration upon reproduction of an information recording/reproducing apparatus in a third embodiment.

FIG. 14 is a flowchart conceptually showing a flow of a reproduction operation and display operation of the information recording/reproducing apparatus in the third embodiment.

FIG. 15 is a diagram showing one specific example of a menu displayed by a GUI display apparatus, which is one example of the displaying device in the third embodiment.

FIG. 16 is a diagram showing another specific example of the menu displayed by the GUI display apparatus, which is one example of the displaying device in the third embodiment.

### DESCRIPTION OF REFERENCE CODES

100 optical disc
200 hard disk
300 information recording/reproducing apparatus
304 ID judging device
305 GUI controller
306 display apparatus
307 controller
400a history information
400b history information

### BEST MODE FOR CARRYING OUT THE INVENTION

Hereinafter, the best mode for carrying out the present invention will be explained in each embodiment in order with reference to the drawings.

Hereinafter, the embodiments of the present invention will be described with reference to the drawings.

### FIRST EMBODIMENT OF INFORMATION RECORDING/REPRODUCING APPARATUS

### (Basic Configuration Upon Recording)

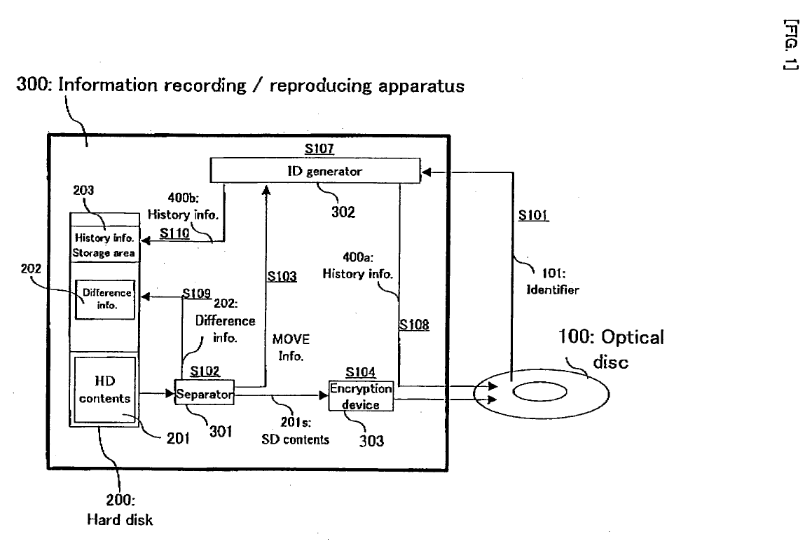

Firstly, with reference to FIG. 1, an explanation will be given for the basic configuration upon recording of a first embodiment of an information recording/reproducing apparatus (an information recording apparatus or information reproducing apparatus) of the present invention. FIG. 1 is a block diagram conceptually showing the basic configuration upon recording of the information recording/reproducing apparatus in the embodiment.

As shown in FIG. 1, an information recording/reproducing apparatus 300 in this embodiment performs a MOVE process in which HD contents, which are recorded in a hard disk 200 and which constitute one example of the “first content information” of the present invention, are moved to an optical disc 100, such as a DVD-RW, which is compatible with the copyright protection technology, such as CPRM. Incidentally, one example of the “first recording medium” of the present invention is the hard disk 200. One example of the “second recording medium” of the present invention is the optical disc 100.

For the MOVE process, the information recording/reproducing apparatus 300 is further provided with: a separator 301, which constitutes one example of the “down-convert device” of the present invention; an ID generator 302, which constitutes one example of the “history information generating device” of the present invention; and an encryption device 303.

### (Recording Operation in Move Process)

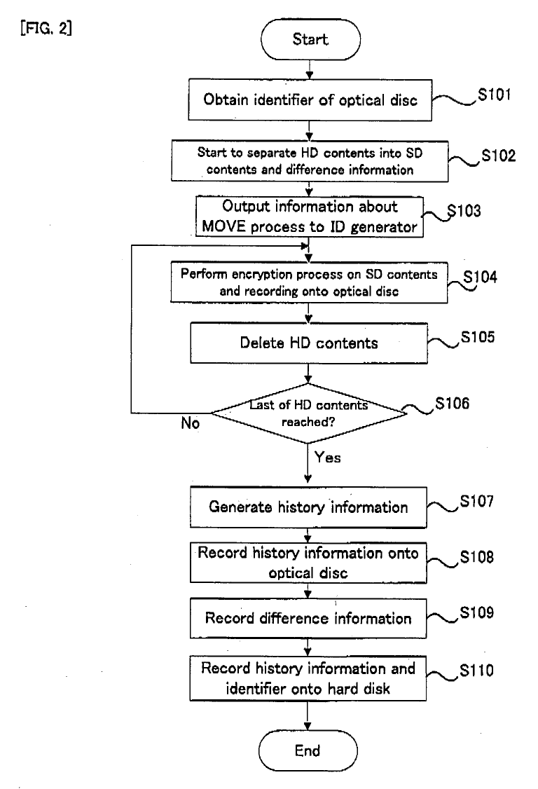

Next, in addition to FIG. 2, with reference to FIG. 1 described above, as occasion demands, the recording operation in the MOVE process of the information recording/reproducing apparatus 300 in this embodiment will be explained, with its detailed configuration. FIG. 2 is a flowchart conceptually showing a flow of the MOVE process of the information recording/reproducing apparatus in the first embodiment. Incidentally, the step numbers shown in FIG. 1 described above are the same as those in FIG. 2.

As shown in FIG. 2, firstly, an identifier 101 of the optical disc 100 is obtained by the ID generator 302 (step S101). Incidentally, this identifier 101 may be a media ID which is recorded in a barcode-like pattern in a NBCA (Narrow Burst Cutting Area), or other disc ID or disc information, in the case of a DVD as one specific example of the optical disc 100. Alternatively, a combination of these IDs may be regarded as one identifier. Namely, any information can be used as the identifier in the embodiment, if capable of specifying only one optical disc 100 with SD contents recorded, from among a huge number of optical discs 100.

Then, the HD contents recorded on the hard disk 200 are separated into the SD contents and the “difference information” of the present invention, on the separator 301 (separation is started) (step S102). Incidentally, the separator 301 may be constructed to perform TS-PS (Transport Stream-Program Stream) conversion.

Then, information about the MOVE process is outputted to the ID generator 302 (step S103). Incidentally, the information about the MOVE process is used in the generation of history information, described later.

Then, the encryption device 303 performs an encryption process for performing copyright protection, such as a CPRM process, on the SD contents, and performs recording onto a CPRM-compatible optical disc, such as a DVD-RW (step S104). Specifically, an encryption key is generated depending on a device key owned by the information recording/reproducing apparatus 300, a media key (e.g. MKB (Media Key Block)) recorded in advance on the optical disc 100, or the like. Then, on the basis of the encryption key, the contents to be recorded (in this case, the SD contents) are encrypted. Then, the encrypted SD contents are recorded onto the optical disc 100.

Then, in order to satisfy the requirements for the MOVE process, the HD contents recorded on the hard disk 200 are deleted, simultaneously with or in parallel with the recording of the SD contents (step S105).

Then, it is judged whether or not the down-converting or the like is performed up to the last portion of the HD contents (i.e. whether or not the last of the HD contents is reached) (step S106). Namely, it is judged whether or not the SD contents corresponding to the last portion of the HD contents are recorded onto the optical disc 100.

As a result of the judgment, if it is judged that the down-converting or the like is not performed up to the last portion of the HD contents (the step S106: No), the operational flow returns to the step S104 again. Then, the down-converting of the HD contents, the separation into the difference information, and the recording of the SD contents onto the optical disc 100 (and further, the deletion of the HD contents recorded on the hard disk 200) are continued.

On the other hand, if it is judged that the down-converting or the like is performed up to the last portion of the HD contents (the step S106: Yes), history information 400 of the present invention is generated by the ID generator 302 on the basis of the identifier obtained in the step S101 and the information about the MOVE process obtained in the step S103 (step S107).

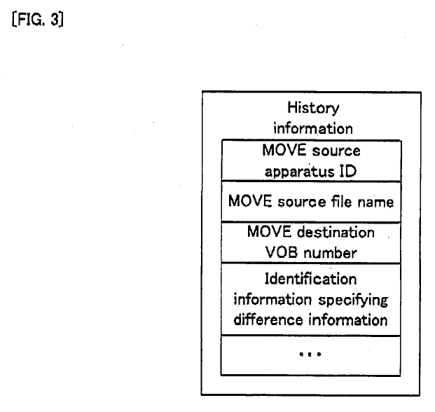

The history information will be described in more detail, with reference to FIG. 3. FIG. 3 is a data structure view conceptually showing the “history information” of the present invention.

As shown in FIG. 3, the history information is information indicating an operation history about the MOVE process. For example, it includes information uniquely indicating a relationship between the information recording/reproducing apparatus that performed the MOVE process and the optical disc on which the contents are recorded by the MOVE process, or the like. More specifically, it includes: (i) a MOVE source apparatus ID, which constitutes one example of the information capable of specifying an information recording apparatus for performing the MOVE process” in the present invention; (ii) a MOVE source file name; (iii) a MOVE destination VOB number; and (iv) identification information for specifying the difference information.

The MOVE source apparatus ID is information capable of specifying the information recording/reproducing apparatus for performing the MOVE process. Specifically, it is an identification number or the like for specifying the information recording/reproducing apparatus which actually performed the MOVE process on the HD contents. More specifically, it may be an apparatus ID (device ID) allocated to each information recording/reproducing apparatus, or may be other information if capable of specifying only one information recording/reproducing apparatus that performed the MOVE process.

The MOVE source file name is information for specifying the HD contents targeted for the MOVE process (or the HD contents). For example, it is a file name (or a title name, program name, etc.) of the moved HD contents in the information recording/reproducing apparatus.

The MOVE destination VOB number is information for specifying a recording position in the optical disc 100 of the SD contents recorded as a result of the MOVE process (or the SD contents). For example, in case of a DVD as one specific example of the optical disc 100, it indicates a VOB number.

The identification information for specifying the difference information is information for specifying the difference information generated in the separation of the HD contents. For example, it may be information indicating a predetermined address at which the difference information is recorded on the hard disk 200.

Incidentally, instead of the history information including all the information described above, the history information including a part of the information may be used. Moreover, as the history information, it may be constructed to include various information other than the above. The point is that any information that indicates the operation history about the MOVE process, that can properly protect the copyright of the contents targeted for the MOVE process, and that can ensure another reproduction operation of the once-down-converted HD contents, is included in the scope of the history information in the embodiment.

In FIG. 2 and FIG. 1 again, the history information 400 generated in the step S107 is recorded onto the optical disc 100 (step S108). Here, sometimes, a plurality of types (i.e. a plurality of tiles) of the SD contents are recorded on the optical disc 100. Therefore, the history information 400 related to the recording of the SD contents (i.e. the MOVE process) is preferably recorded onto the optical disc 100 in association with the recorded SD contents. For example, the history information 400 may be associated with the SD contents by including the file name in the optical disc 100 of the moved HD contents (i.e. the file name in the optical disc 100 of the SD contents) into the history information 400. Alternatively, the history information 400 may be associated with the SD contents by using the “MOVE destination VOB number” included in the history information 400.

Then, the difference information 202 separated in the step S102 is recorded, for example, at the predetermined address on the hard disk 200, which is described in the above-mentioned history information 400 (step S109).

The identifier 101 of the optical disc 100 obtained in the step S101, and the history information 400 generated in the step S107 are recorded by the ID generator 302 into a history information storage area 203 in the hard disk 200 (step S110).

### (Basic Configuration Upon Reproduction)

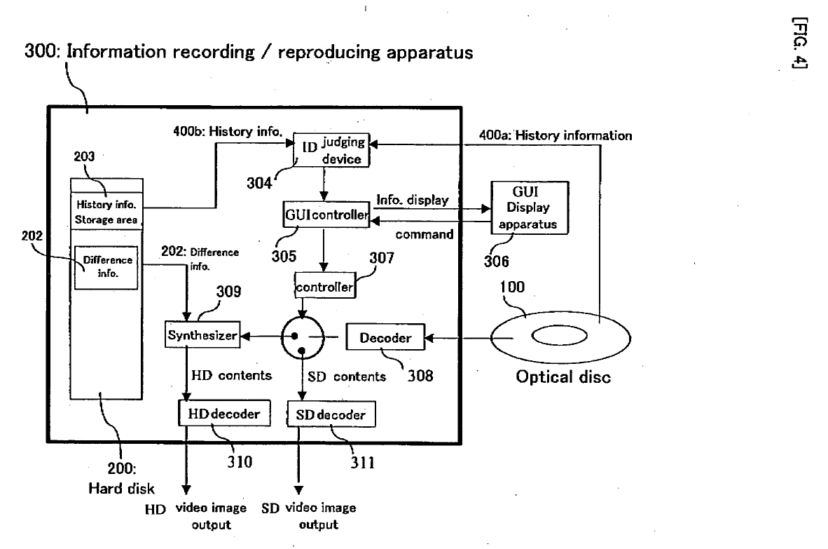

Next, with reference to FIG. 4, an explanation will be given for the basic configuration upon reproduction of the first embodiment of the information recording/reproducing apparatus (the information recording apparatus or information reproducing apparatus) of the present invention. FIG. 4 is a block diagram conceptually showing the basic configuration upon reproduction of the information recording/reproducing apparatus in the first embodiment. Incidentally, the same elements as those in the basic configuration upon recording, explained in FIG. 1 described above, carry the same numerical reference numbers, and the explanation thereof will be omitted.

As shown in FIG. 4, the information recording/reproducing apparatus 300 in the embodiment displays, to a user, the information about whether or not the SD contents recorded on the optical disc 100 can be restored and reproduced to the HD contents in the MOVE process by the information recording/reproducing apparatus 300. Moreover, the information recording/reproducing apparatus 300 is operable to selectively reproduce the HD contents or SD contents, as occasion demands.

For the reproduction and display operations, the information recording/reproducing apparatus 300 is provided with: an ID judging device 304, which constitutes one example of the “first judging device” of the present invention; a GUI (Graphical User Interface) controller 305 and a GUI display apparatus 306, which constitute one example of the “displaying device” of the present invention; a controller 307, which constitutes one example of the “controlling device” and the “second judging device” of the present invention; a decoder 308 compatible with the copyright protection technology, such as CPRM; a synthesizer 309, which constitutes one example of the “content information generating device” of the present invention; and a HD decoder 310 and a SD decoder 311, which constitute one example of the “reproducing device” of the present invention. More specifically, on the GUI display apparatus 306, for example, on a DVD recorder equipped with a HDD compatible with Hi-vision recording, a menu displayed on a TV screen is operated by using a remote controller or the like. Moreover, under the control of the GUI controller 305, the judgment result by the ID judging device 304 is displayed on the GUI display apparatus, and a user's command inputted on the GUI display apparatus is exchanged. Moreover, on the controller 305, the contents to be decoded are changed in response to the user's command.

### (Reproduction and Display Operations)

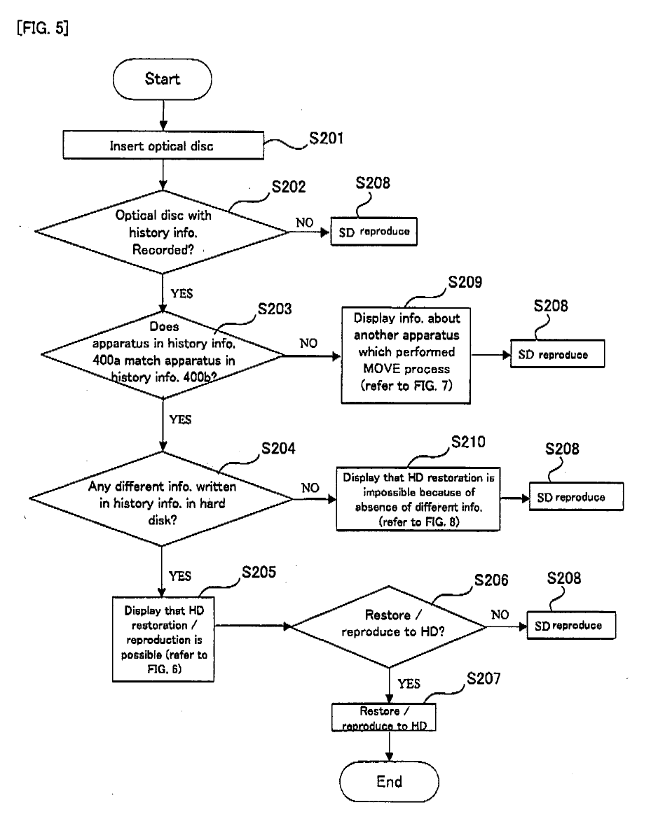

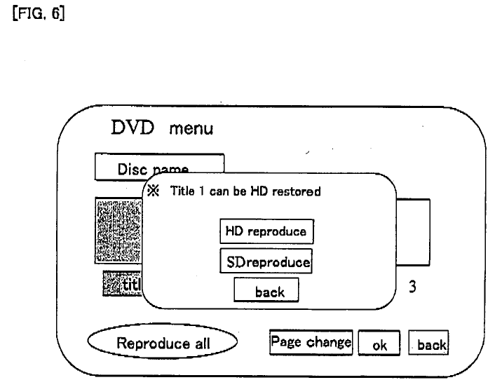

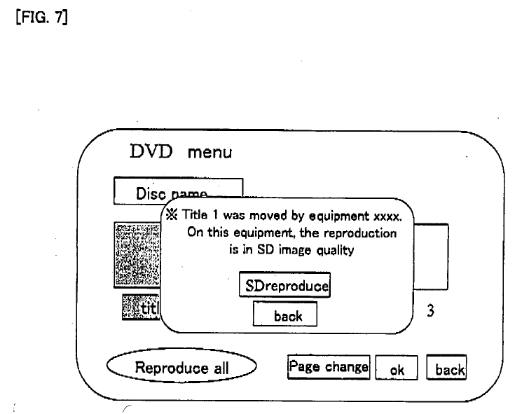

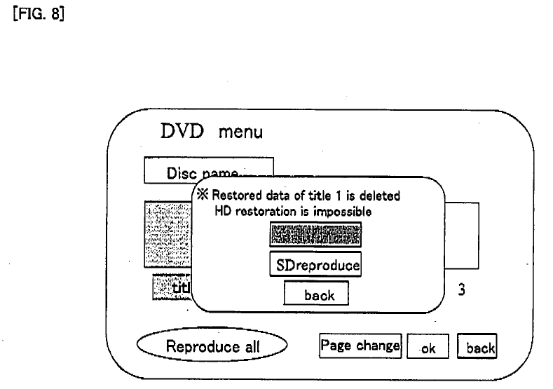

Next, in addition to FIG. 5, with reference to FIG. 4 described above, as occasion demands, the reproduction and display operations of the information recording/reproducing apparatus 300 in this embodiment will be explained, with its detailed configuration. FIG. 5 is a flowchart conceptually showing a flow of the reproduction operation and display operation of the information recording/reproducing apparatus in the first embodiment. Incidentally, the step numbers shown in FIG. 4 described above match the step numbers in FIG. 5. FIG. 6 is a diagram showing one specific example of the menu displayed by the GUI display apparatus, which is one example of the displaying device in the first embodiment. FIG. 7 is a diagram showing another specific example of the menu displayed by the GUI display apparatus, which is one example of the displaying device in the first embodiment. FIG. 8 is a diagram showing another specific example of the menu displayed by the GUI display apparatus, which is one example of the displaying device in the first embodiment.

As shown in FIG. 5, firstly, the optical disc 100 with the SD contents recorded is inserted onto the information recording/reproducing apparatus (step S201).

Then, it is judged by the ID judging device 304 whether or not history information 400a is recorded on the optical disc 100 (step S202). Here, if the history information 400a is recorded on the optical disc 100 (the step S202: Yes), under the control of the ID judging device 304, the history information 400a is obtained from the optical disc 100, and the MOVE source apparatus ID described in the obtained history information 400a and the MOVE source apparatus ID described in history information 400b recorded on the hard disk 200 are verified to judge whether or not they match (step S203). Here, if the MOVE source apparatus ID described in the history information 400a of the optical disc 100 matches the MOVE source apparatus ID described in the history information 400b of the hard disk 200 (the step S203: Yes), under the control of the controller 307, it is further judged whether or not there is difference information 202 in the hard disk 200 (step S204). Here, if there is the difference information 202 in the hard disk 200 (the step S204: Yes), under the control of the GUI controller 305, GUI display apparatus 306 displays the indication that the restoration/reproduction to the HD contents (or HD restoration/reproduction) is possible (step S205). Incidentally, more specifically, as shown in FIG. 6, it is shown to the user that the HD restoration/reproduction is possible, and a menu is displayed with buttons or the like to let the user select whether to reproduce the HD contents or the SD contents.

Then, whether or not to perform the HD restoration/reproduction is determined by the user (step S206). Incidentally, refer to the menu in FIG. 6 described above. Here, if the HD restoration/reproduction is selected (the step S206: Yes), the HD restoration/reproduction is performed. On the other hand, if the HD restoration/reproduction is not selected (the step S206: No), the SD contents are reproduced (step S208).

On the other hand, as a result of the judgment in the step S203, if the MOVE source apparatus ID described in the history information 400a of the optical disc 100 does not match the MOVE source apparatus ID described in the history information 400b of the hard disk 200 (the step S203: No), under the control of the GUI controller 305, the GUI display apparatus 306 displays the indication that the HD restoration/reproduction can be performed by the information recording/reproducing apparatus specified by the MOVE source apparatus ID described in the history information 400a of the optical disc 100. Incidentally, more specifically, as shown in FIG. 7, it is shown to the user that the MOVE process is performed by the information recording/reproducing apparatus specified by the MOVE source apparatus ID described in the history information 400a, and a menu is displayed with a button or the like to let the user select the reproduction of the SD contents. Then, the SD contents are reproduced (step S208).

### SECOND EMBODIMENT OF INFORMATION RECORDING/REPRODUCING APPARATUS

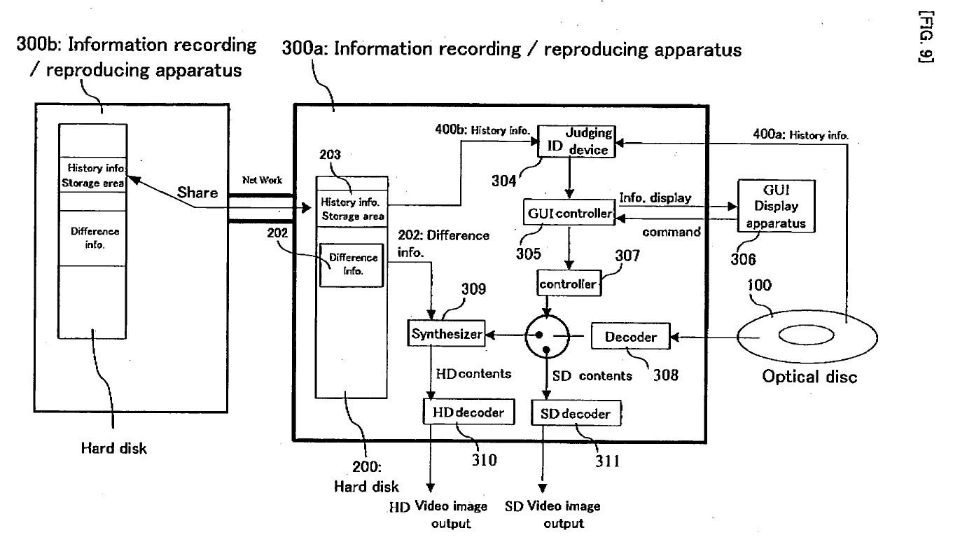

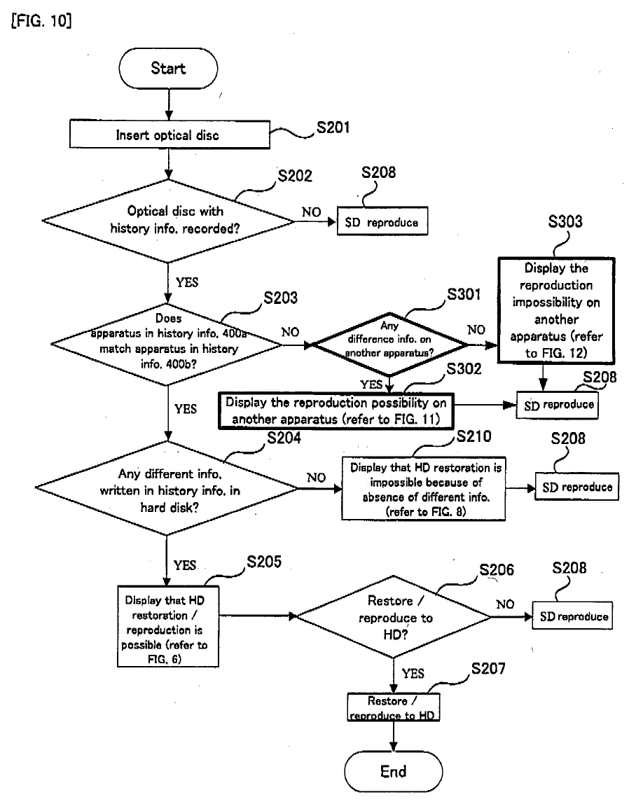

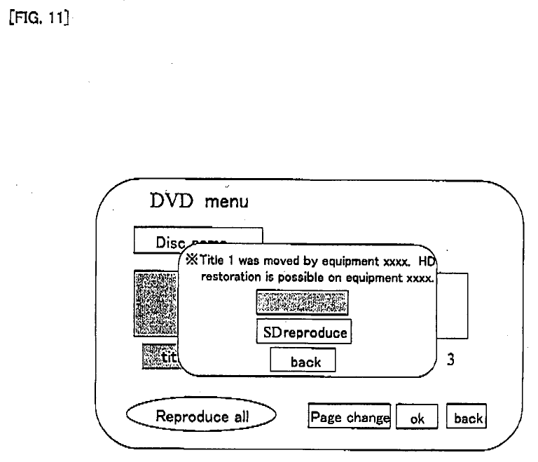

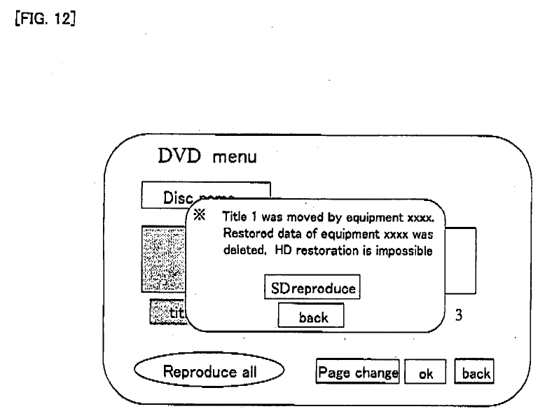

Next, with reference to FIG. 9 to FIG. 12, an explanation will be given for the basic configuration upon reproduction of a second embodiment of the information recording/reproducing apparatus (the information recording apparatus or information reproducing apparatus) of the present invention. FIG. 9 is a block diagram conceptually showing the basic configuration upon reproduction of an information recording/reproducing apparatus in a second embodiment. FIG. 10 is a flowchart conceptually showing a flow of the reproduction operation and display operation of the information recording/reproducing apparatus in the second embodiment. Incidentally, in FIG. 10, the same steps as those in FIG. 5 described above, carry the same step numbers, and the explanation thereof will be omitted. FIG. 11 is a diagram showing one specific example of a menu displayed by a GUI display apparatus, which is one example of the displaying device in the second embodiment. FIG. 12 is a diagram showing another specific example of the menu displayed by the GUI display apparatus, which is one example of the displaying device in the second embodiment.

If the SD contents recorded on the optical disc 100 cannot be restored and reproduced to the HD contents in the MOVE process by an information recording/reproducing apparatus 300a in the second embodiment, the information recording/reproducing apparatus 300a more accurately judges whether or not the HD restoration/reproduction can be performed by another information recording/reproducing apparatus 300b. Then, the judgment result can be displayed to the user. Incidentally, the configurations of information recording/reproducing apparatuses 300a and 300b are substantially the same as that of the information recording/reproducing apparatuses 300 in the first embodiment.

As shown in FIG. 9, the information recording/reproducing apparatus 300a in the second embodiment and another information recording/reproducing apparatus 300b can share, via a network 500, the history information recorded in the history information storage area in the hard disk and recording area management information in the hard disk. More specifically, under the control of the controller 307, such as, for example, a CPU, it can be judged whether or not the difference information is actually recorded at the address in the hard disk of the difference information, which is described in the history information, on the basis of the recording area management information.

Therefore, as shown in FIG. 10, as a result of the judgment in the step S203, if the MOVE source apparatus ID described in the history information 400a of the optical disc 100 does not match the MOVE source apparatus ID described in the history information 400b of the hard disk 200 (the step S203: No), under the control of the controller 307, it is judged whether or not there is the difference information on another information recording/reproducing apparatus 300b specified by the MOVE source apparatus ID described in the history information 400a of the optical disc 100 (step S301). Here, if there is the difference information on another information recording/reproducing apparatus 300b (the step S301: Yes), as shown in FIG. 11, a menu is displayed to the user with (i) the indication that the MOVE process is performed by another information recording/reproducing apparatus 300b specified by the MOVE source apparatus ID described in the history information 400a, (ii) the indication that the HD restoration/reproduction can be performed on another information recording/reproducing apparatus 300b, and (iii) a button to let the user select the reproduction of the SD contents on the information recording/reproducing apparatus 300a, or the like (step S302). On the other hand, if there is no difference information on another information recording/reproducing apparatus 300b (the step S301: No), as shown in FIG. 12, a menu is displayed to the user with (i) the indication that the MOVE process is performed by another information recording/reproducing apparatus 300b specified by the MOVE source apparatus ID described in the history information 400a, (ii) the indication that the HD restoration/reproduction cannot be performed on another information recording/reproducing apparatus 300b, and (iii) a button to let the user select the reproduction of the SD contents on the information recording/reproducing apparatus 300a, or the like (step S303).

### THIRD EMBODIMENT OF INFORMATION RECORDING/REPRODUCING APPARATUS

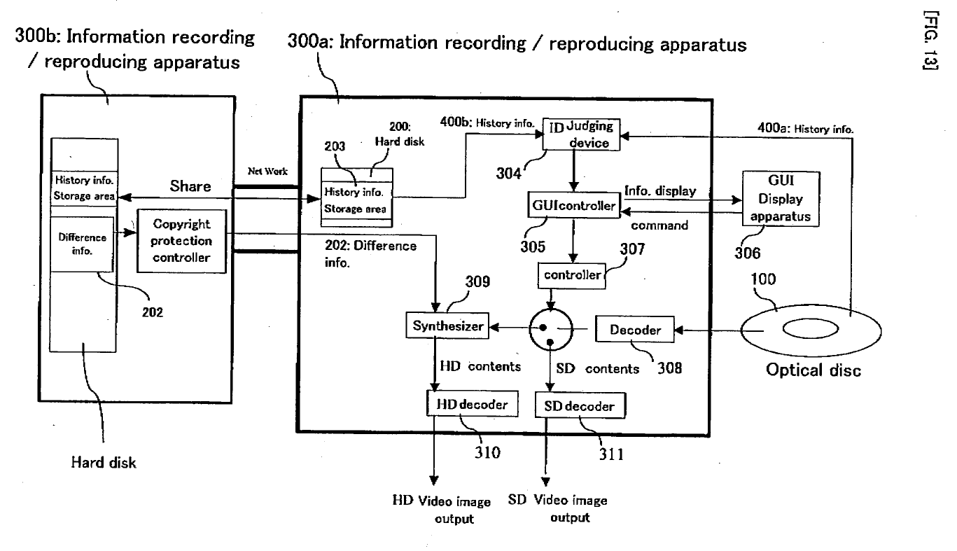

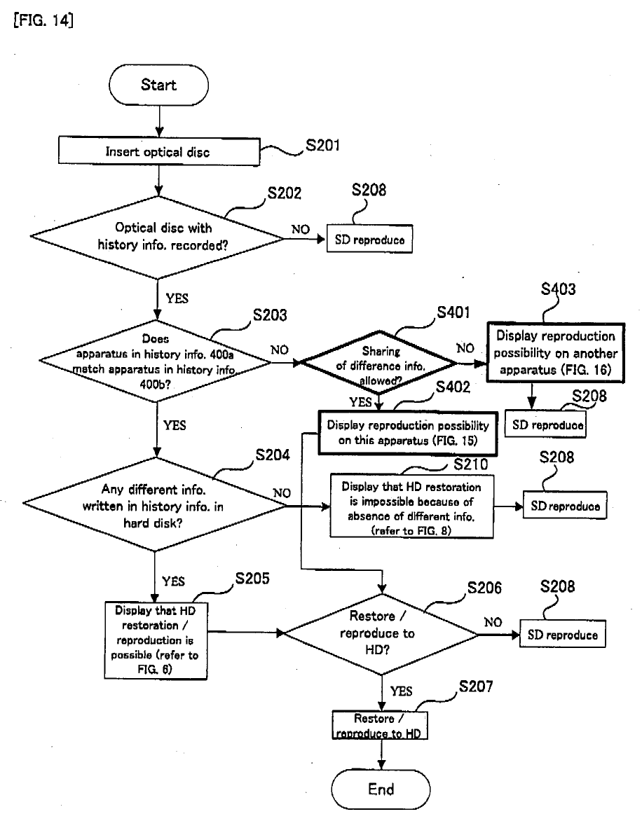

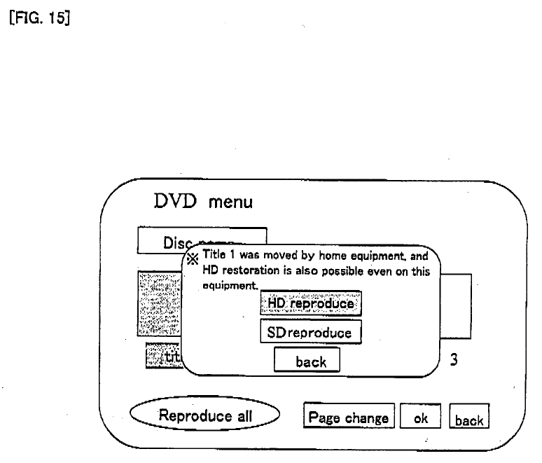

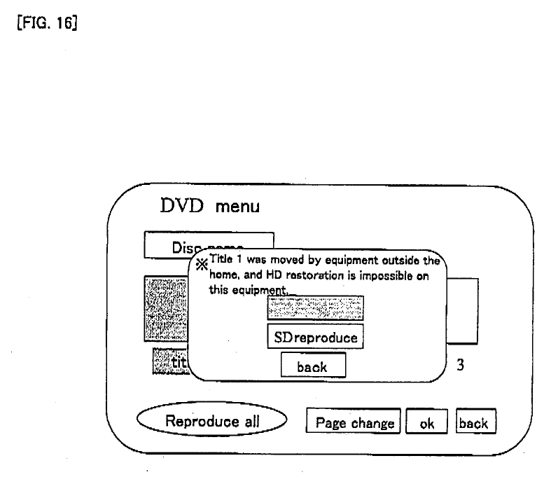

Next, with reference to FIG. 13 to FIG. 16, an explanation will be given for the basic configuration upon reproduction of a third embodiment of the information recording/reproducing apparatus (the information recording apparatus or information reproducing apparatus) of the present invention. FIG. 13 is a block diagram conceptually showing the basic configuration upon reproduction of an information recording/reproducing apparatus in a third embodiment. FIG. 14 is a flowchart conceptually showing a flow of the reproduction operation and display operation of the information recording/reproducing apparatus in the third embodiment. Incidentally, in FIG. 14, the same steps as those in FIG. 5 described above, carry the same step numbers, and the explanation thereof will be omitted. FIG. 15 is a diagram showing one specific example of a menu displayed by a GUI display apparatus, which is one example of the displaying device in the third embodiment. FIG. 16 is a diagram showing another specific example of the menu displayed by the GUI display apparatus, which is one example of the displaying device in the third embodiment.

An information recording/reproducing apparatus 300a in the third embodiment obtains, via a network, the difference information recorded on another information recording/reproducing apparatus 300b, if the SD contents recorded on the optical disc 100 are moved by another information recording/reproducing apparatus 300b and cannot be restored nor reproduced to the HD contents by the information recording/reproducing apparatus 300a. Then, the information recording/reproducing apparatus 300a is operable to restore and reproduce the SD contents recorded on the optical disc 100 to the HD contents. Incidentally, the configuration of the information recording/reproducing apparatus 300a in the third embodiment is substantially the same as that of the information recording/reproducing apparatus 300 in the first embodiment.

As shown in FIG. 13, the information recording/reproducing apparatus 300a in the third embodiment and another information recording/reproducing apparatus 300b can share, via a network 500, the history information recorded in the history information storage area in the hard disk and the recording area management information in the hard disk. Also, each apparatus has a copyright protection controller 600a (or 600b). The copyright protection controller 600a (or 600b) allows the sharing of the difference information via the network 500, only in a limited range, such as, for example, at home, under a predetermined encryption system.

Therefore, as shown in FIG. 14, as a result of the judgment in the step S203, if the MOVE source apparatus ID described in the history information 400a of the optical disc 100 does not match the MOVE source apparatus ID described in the history information 400b of the hard disk 200 (the step S203: No), under the control of the copyright protection controller 600a, it is judged whether or not to allow the sharing of the difference information recorded on another information recording/reproducing apparatus 300b specified by the MOVE source apparatus ID described in the history information 400a of the optical disc 100 (step S401). Here, if the sharing of the difference information is allowed on another information recording/reproducing apparatus 300b (the step S401: Yes), as shown in FIG. 15, a menu is displayed to the user with (i) the indication that the MOVE process is performed by another information recording/reproducing apparatus 300b specified by the MOVE source apparatus ID described in the history information 400a, (ii) the indication that the sharing of the difference information is allowed because there is another information recording/reproducing apparatus 300b at home, and (iii) the HD restoration/reproduction can be performed on the information recording/reproducing apparatus 300a, or the like (step S402). On the other hand, if the sharing of the difference information is not allowed on another information recording/reproducing apparatus 300b (the step S401: No), as shown in FIG. 16, a menu is displayed to the user with (i) the indication that the MOVE process is performed by another information recording/reproducing apparatus 300b specified by the MOVE source apparatus ID described in the history information 400a, (ii) the indication that the sharing of the difference information is not allowed because there is not another information recording/reproducing apparatus 300b at home, and (iii) a button to let the user select the reproduction of the SD contents on the information recording/reproducing apparatus 300a, or the like (step S403).

As explained above, according to the information recording/reproducing apparatus 300 in the embodiment, even after the HD contents recorded on the hard disk 200 are converted to the SD contents and recorded onto the optical disc 100, the HD contents can be reproduced again by performing the reproduction operation using scramble data, as described above. Moreover, even if the HD contents are converted to the SD contents and recorded onto the optical disc 100, only the original HD contents or the difference information which is totally different from the SD contents, are recorded on the hard disk 200. Thus, the copyright of the contents can be preferably protected.

In addition, the history information includes the information capable of specifying only one information recording/reproducing apparatus 300 that performed one MOVE process. Thus, even if the optical disc 100 is inserted onto another information recording/reproducing apparatus 300 that does not perform one MOVE process, the information indicating the one information recording/reproducing apparatus 300 can be displayed to the user. Moreover, the HD contents can be restored and reproduced on the basis of the history information recorded on the hard disk 200 in the one information recording/reproducing apparatus 300, so that the user can watch the content information, highly conveniently.

Moreover, in the above-mentioned embodiments, the hard disk 200 and the optical disc 100 are explained as one example of the recording medium, and the recorder (or player) associated with the hard disk 200 and the optical disc 100 is explained as one example of the information recording/reproducing apparatus. The present invention, however, is not limited to the hard disk and the optical disc, and the recorder (or player) thereof, and can be applied to other various recording media and the recorders (or players) thereof.

The present invention is not limited to the above-described embodiments, and various changes may be made, if desired, without departing from the essence or spirit of the invention which can be read from the claims and the entire specification. An information recording apparatus and method, an information reproducing apparatus and method, an information recording/reproducing apparatus and method, and a computer program for recording control, for reproduction control, or for recording/reproduction control, which involve such changes, are also intended to be within the technical scope of the present invention.

### INDUSTRIAL APPLICABILITY

The information recording apparatus and method, the information reproducing apparatus and method, the information recording/reproducing apparatus and method, and the computer program of the present invention can be applied to an information recording/reproducing apparatus, such as a DVD recorder and a DVD player, for example. Moreover, they can be applied to an information recording/reproducing apparatus or the like, which is mounted on or can be connected to various computer equipment for consumer use or business use, for example.

1-22. (canceled)

23. An information recording apparatus for performing a MOVE process of moving first content information in first reproduction quality, which is recorded on a first recording medium, to a second recording medium, said information recording apparatus comprising:
a MOVE processing device for performing the MOVE process; and
a history information generating device for generating history information, which at least includes information about a history of the MOVE process and information capable of specifying said information recording apparatus,
said MOVE processing device comprising:
a down-convert device for down-converting the first content information to second content information in second reproduction quality, which is lower definition than the first reproduction quality;
a first recording device for recording at least the second content information out of the generated history information and the second content information onto the second recording medium; and
a deleting device for deleting the first content information recorded on the first recording medium, if the second content information is recorded onto the second recording medium,
the down-convert device separating the first content information into the second content information and difference information which can be restored and reproduced by adding it to the second content information but which cannot be reproduced solo, to thereby perform the down-converting.

24. The information recording apparatus according to claim 23, wherein the first recording device further performs a predetermined encryption process on at least one of the second content information and the history information.

25. The information recording apparatus according to claim 23, wherein
said MOVE processing device comprises:
a scrambling device for generating scramble information instead of deleting the first content information by performing a scramble process on the first content information on the basis of a predetermined scramble key, and
said history information generating device generates history information further indicating a history of the scramble process.

26. The information recording apparatus according to claim 23, further comprising a second recording device for recording at least one of the difference information and the history information onto the first recording medium.

27. The information recording apparatus according to claim 23, wherein said history information generating device generates, as portion of the history information, information capable of specifying at least one of the first content information on which the MOVE process is performed, the second recording medium, a recording position on the second recording medium of the second content information on which the MOVE process is performed, and difference information separated by the MOVE process.

28. An information reproducing apparatus for reproducing the first content information moved from a first recording medium to a second recording medium by an information recording apparatus,
said information recording apparatus for performing a MOVE process of moving the first content information in first reproduction quality, which is recorded on the first recording medium, to the second recording medium, said information recording apparatus comprising:
a MOVE processing device for performing the MOVE process; and
a history information generating device for generating history information, which at least includes information about a history of the MOVE process and information capable of specifying said information recording apparatus,
said MOVE processing device comprising:
a down-convert device for down-converting the first content information to second content information in second reproduction quality, which is lower definition than the first reproduction quality;
a first recording device for recording at least the second content information out of the generated history information and the second content information onto the second recording medium; and
a deleting device for deleting the first content information recorded on the first recording medium, if the second content information is recorded onto the second recording medium,
the down-convert device separating the first content information into the second content information and difference information which can be restored and reproduced by adding it to the second content information but which cannot be reproduced solo, to thereby perform the down-converting
said information reproducing apparatus comprising:
an obtaining device for obtaining history information recorded on the second recording medium;
a first judging device for judging whether or not an information recording apparatus specified by the obtained history information matches the information recording apparatus which performed the MOVE process;
a displaying device for displaying whether or not the first content information can be reproduced on said information reproducing apparatus;
a content information generating device for generating the first content information on the basis of the history information;
a reproducing device for reproducing the generated first content information or the second content information recorded on the second recording medium; and
a controlling device for controlling said displaying device to display an indication that the first content information can be reproduced, controlling said content information generating device to generate the first content information, and controlling said reproducing device to reproduce the generated first content information, if it is judged by said first judging device that the both apparatuses match.

29. The information reproducing apparatus according to claim 28, further comprising: a second judging device for judging whether or not the difference information or the scramble information is recorded on the first recording medium on which the MOVE process is performed by the matching information recording apparatus,
said controlling device controlling said displaying device to display an indication that the first content information can be reproduced, controlling said content information generating device to generate the first content information, and controlling said reproducing device to reproduce the generated first content information, if it is judged by said second judging device that the information is recorded.

30. The information reproducing apparatus according to claim 29, wherein said controlling device controls said displaying device to display an indication that the first content information cannot be reproduced and controls said reproducing device to reproduce the second content information, if it is judged by said second judging device that the information is not recorded.

31. The information reproducing apparatus according to claim 28, wherein
said displaying device is further capable to display information indicating the information recording apparatus specified by the history information recorded on the second recording medium, and
said controlling device controls said displaying device to display an indication that the first content information cannot be reproduced and information indicating the specified information recording apparatus, and controls said reproducing device to reproduce the second content information, if it is judged by said first judging device that the both apparatuses do not match.

32. The information reproducing apparatus according to claim 28, wherein
the second content information is recorded on the second recording medium through a predetermined encryption process, and
said reproducing device further decodes and reproduces the second content information.

33. The information reproducing apparatus according to claim 28, wherein said content information generating device adds the difference information to the second content information, to thereby generate the first content information.

34. The information reproducing apparatus according to claim 31, wherein
recording area management information can be recorded on the first recording medium, the recording area management information being intended to manage whether a recording area is recorded condition or unrecorded condition can be recorded,
said information reproducing apparatus is connected to an external network through which information can be shared with another information reproducing apparatus, and
said controlling device controls said displaying device to share, via the external network, the history information and the recording area management information, and to display information indicating whether or not there is the difference information, in the another information reproducing apparatus.

35. The information reproducing apparatus according to claim 34, further comprising a copyright protecting device for allowing or prohibiting the sharing of information between said information reproducing apparatus and another information reproducing apparatus,
said controlling device controlling said content information generating device to share the difference information via the external network and to generate the first content information on the basis of the shared difference information, and controls said reproducing device to reproduce the generated first content information, if the sharing of the difference information is allowed by said copyright protecting device.

36. An information reproducing method on an information reproducing apparatus comprising a reproducing device for reproducing the first content information moved from the first recording medium to the second recording medium by the information recording apparatus according to claim 23 or reproducing the second content information recorded on the second recording medium, said information reproducing method comprising:
an obtaining process of obtaining history information recorded on the second recording medium;
a first judging process of judging whether or not an information recording apparatus specified by the obtained history information matches the information recording apparatus which performed the MOVE process;
a displaying process of displaying whether or not the first content information can be reproduced on said information reproducing apparatus;
a content information generating process of generating the first content information on the basis of the history information; and
a controlling process of controlling said displaying process to display an indication that the first content information can be reproduced, controlling said content information generating process to generate the first content information, and controlling said reproducing device to reproduce the generated first content information, if it is judged by said first judging device that the both apparatuses match.

37. An information recording/reproducing apparatus for performing a MOVE process of moving first content information in first reproduction quality, which is recorded on a first recording medium, to a second recording medium, said information recording/reproducing apparatus comprising:
a MOVE processing device for performing the MOVE process;
a history information generating device for generating history information, which at least includes information about a history of the MOVE process and information capable of specifying said information recording apparatus;
an obtaining device for obtaining history information recorded on the second recording medium;
a first judging device for judging whether or not an information recording apparatus specified by the obtained history information matches the information recording apparatus which performed the MOVE process;
a displaying device for displaying whether or not the first content information can be reproduced on said information reproducing apparatus;
a content information generating device for generating the first content information on the basis of the history information;
a reproducing device for reproducing the generated first content information or the second content information recorded on the second recording medium; and
a controlling device for controlling said displaying device to display an indication that the first content information can be reproduced, controlling said content information generating device to generate the first content information, and controlling said reproducing device to reproduce the generated first content information, if it is judged by said first judging device that the both apparatuses match.

38. An information recording/reproducing method on an information recording/reproducing apparatus for performing a MOVE process of moving first content information in first reproduction quality, which is recorded on a first recording medium, to a second recording medium, said information recording/reproducing apparatus comprising a reproducing device for reproducing various information, said information recording/reproducing method comprising:
a MOVE processing process of performing the MOVE process;
a history information generating process of generating history information, which at least includes information about a history of the MOVE process and information capable of specifying said information recording apparatus;
an obtaining process of obtaining history information recorded on the second recording medium;
a first judging process of judging whether or not an information recording apparatus specified by the obtained history information matches the information recording apparatus which performed the MOVE process;
a displaying process of displaying whether or not the first content information can be reproduced on said information reproducing apparatus;
a content information generating process of generating the first content information on the basis of the history information; and
a controlling device for controlling said displaying process to display an indication that the first content information can be reproduced, controlling said content information generating process to generate the first content information, and controlling said reproducing device to reproduce the generated first content information, if it is judged by said first judging device that the both apparatuses match.

39. A computer program of instructions for reproduction control and for tangibly embodying a program of instructions executable by a computer provided in an information reproducing apparatus, to make the computer function as portion of an obtaining device, a first judging device, a displaying device, a content information generating device, a reproducing device, and a controlling device,
said information reproducing apparatus for reproducing a first content information moved from a first recording medium to a second recording medium by an information recording apparatus,
said information recording apparatus for performing a MOVE process of moving the first content information in first reproduction quality, which is recorded on the first recording medium, to the second recording medium, said information recording apparatus comprising:
a MOVE processing device for performing the MOVE process; and
a history information generating device for generating history information, which at least includes information about a history of the MOVE process and information capable of specifying
said information recording apparatus,
said MOVE processing device comprising:
a down-convert device for down-converting the first content information to second content information in second reproduction quality, which is lower definition than the first reproduction quality;
a first recording device for recording at least the second content information out of the generated history information and the second content information onto the second recording medium; and
a deleting device for deleting the first content information recorded on the first recording medium, if the second content information is recorded onto the second recording medium,
the down-convert device separating the first content information into the second content information and difference information which can be restored and reproduced by adding it to the second content information but which cannot be reproduced solo, to thereby perform the down-converting
said information reproducing apparatus comprising:
said obtaining device for obtaining history information recorded on the second recording medium;
said first judging device for judging whether or not an information recording apparatus specified by the obtained history information matches the information recording apparatus which performed the MOVE process;
said displaying device for displaying whether or not the first content information can be reproduced on said information reproducing apparatus;
said content information generating device for generating the first content information on the basis of the history information;
said reproducing device for reproducing the generated first content information or the second content information recorded on the second recording medium; and
said controlling device for controlling said displaying device to display an indication that the first content information can be reproduced, controlling said content information generating device to generate the first content information, and controlling said reproducing device to reproduce the generated first content information, if it is judged by said first judging device that the both apparatuses match.

40. A computer program of instructions for recording control and reproduction control and for tangibly embodying a program of instructions executable by a computer provided in the information recording/reproducing apparatus, to make the computer function as portion of a MOVE processing device, a history information generating device, an obtaining device, a first judging device, a displaying device, a content information generating device, said reproducing device, and a controlling device,
said information recording/reproducing apparatus for performing a MOVE process of moving first content information in first reproduction quality, which is recorded on a first recording medium, to a second recording medium, said information recording/reproducing apparatus comprising:
said MOVE processing device for performing the MOVE process;
said history information generating device for generating history information, which at least includes information about a history of the MOVE process and information capable of specifying said information recording apparatus;
said obtaining device for obtaining history information recorded on the second recording medium;
said first judging device for judging whether or not an information recording apparatus specified by the obtained history information matches the information recording apparatus which performed the MOVE process;
said displaying device for displaying whether or not the first content information can be reproduced on said information reproducing apparatus;
said content information generating device for generating the first content information on the basis of the history information;
said reproducing device for reproducing the generated first content information or the second content information recorded on the second recording medium; and
said controlling device for controlling said displaying device to display an indication that the first content information can be reproduced, controlling said content information generating device to generate the first content information, and controlling said reproducing device to reproduce the generated first content information, if it is judged by said first judging device that the both apparatuses match.
